(19) United States
(12) Patent Application Publication
(10) Pub. No.: US 2018/0161994 A1
(43) Pub. Date: Jun. 14, 2018

(54) CUTTING DEVICE AND SCISSORS

(71) Applicant: SEIKO INSTRUMENTS INC., Chiba-shi, Chiba (JP)

(72) Inventors: Makoto SUZUKI, Chiba-shi, Chiba (JP); Kazuyoshi FURUTA, Chiba-shi, Chiba (JP); Akihiro IINO, Chiba-shi, Chiba (JP); Jun SHINOHARA, Chiba-shi, Chiba (JP)

(21) Appl. No.: 15/579,541

(22) PCT Filed: Jun. 16, 2016
(86) PCT No.: PCT/JP2016/067908

§ 371 Date: Dec. 4, 2017

(30) Foreign Application Priority Data
Jul. 6, 2015 (JP) 2015-135496

(51) Int. Cl. B26B 13/28

(52) U.S. Cl. CPC B26B 13/28

(57) ABSTRACT

A cutting device includes a support shaft, a first blade body which holds the support shaft, a slide bearing mounted on the support shaft, a second blade body provided to overlap the first blade body and rotatably supported on the support shaft via the slide bearing, a fixing member disposed on the support shaft on a side opposite to the first blade body across the slide bearing, and a biasing member disposed between the slide bearing and the fixing member. A regulating portion, which regulates movement of the slide bearing toward the first blade body side with respect to the second blade body, is provided in at least one of the second blade body and the slide bearing, and the slide bearing is biased toward the first blade body side by the biasing member.

### TECHNICAL FIELD

The present invention relates to a cutting device and scissors.

Priority is claimed on Japanese Patent Application No. 2015-135496, filed Jul. 6, 2015, the content of which is incorporated herein by reference.

### BACKGROUND ART

For example, scissors are adopted as a tool having a cutting device. Scissors include a pair of blade bodies, and a support shaft which supports the pair of blade bodies (see, for example, Patent Document 1). In the scissors, one blade body is slidably supported on the support shaft.

### CITATION LIST

### Patent Literature

### [Patent Document 1]

Japanese Unexamined Utility Model Application, First Publication No. H07-5564

### SUMMARY OF INVENTION

### Technical Problem

However, with the scissors including the aforementioned conventional cutting device, there is a case where the support shaft wears due to sliding between the support shaft and the blade bodies supported by the support shaft to cause rattling of the blade bodies. In this case, since a gap is formed between the pair of blade bodies to deteriorate meshing, there is a possibility of degradation of the cutting performance.

The present invention provides a cutting device and scissors capable of maintaining excellent cutting performance.

### Solution to Problem

A cutting device according to a first aspect of the present invention includes a support shaft; a first blade body which holds the support shaft; a slide bearing mounted on the support shaft; a second blade body provided to overlap the first blade body and rotatably supported on the support shaft via the slide bearing; a fixing member disposed on the support shaft on a side opposite to the first blade body across the slide bearing; and a biasing member disposed between the slide bearing and the fixing member, wherein a regulating portion, which regulates movement of the slide bearing toward the first blade body side with respect to the second blade body, is provided in at least one of the second blade body and the slide bearing, and the slide bearing is biased toward the first blade body side by the biasing member.

With such a configuration, since the second blade body is rotatably supported on the support shaft via the slide bearing, the movement of the first blade body and the second blade body can be made smooth. Moreover, at least one of the second blade body and the slide bearing is provided with a regulating portion which regulates the movement of the slide bearing toward the first blade body side with respect to the second blade body. Therefore, when the slide bearing is biased toward the first blade body side by the biasing member, the biasing force of the biasing member acting on the slide bearing is made to act on the second blade body, thereby making it possible to press the second blade body toward the first blade body. As a result, the first blade body and the second blade body are always brought into pressure contact with each other, and the cutting performance can be maintained. Therefore, it is possible to provide the cutting device capable of maintaining excellent cutting performance.

According to the second aspect of the present invention, in the cutting device according to the first aspect of the present invention, a spacer may be interposed between the slide bearing and the biasing member.

With such a configuration, since it is possible to suppress the direct sliding-contact between the slide bearing and the biasing member, an increase in the sliding friction of the slide bearing can be suppressed. Thus, the movement of the first blade body and the second blade body can be made smooth.

According to a third aspect of the present invention, in the cutting device according to the first aspect or the second aspect of the present invention, the biasing member may have a seating surface on the slide bearing side.

With such a configuration, since the biasing member can be brought into contact with the member on the slide bearing side on the surface, an increase in the sliding friction of the slide bearing can be suppressed. Therefore, the movement of the first blade body and the second blade body can be made smooth.

According to a fourth aspect of the present invention, in the cutting device according to any one of the first aspect to the third aspect of the present invention, an outer peripheral surface of the slide bearing may gradually decrease in diameter from the fixing member side to the first blade body side, the second blade body may include a bearing holding hole which holds the slide bearing, and the bearing holding hole may include an inner peripheral surface which gradually decreases in diameter from the fixing member side toward the first blade body side to correspond to the outer peripheral surface of the slide bearing.

With such a configuration, a part of the biasing force of the biasing member acting on the slide bearing toward the first blade body can be directed outward in the radial direction of the slide bearing at a contact portion between the outer peripheral surface of the slide bearing and the inner peripheral surface of the bearing holding hole. Therefore, it is possible to suppress an occurrence of a gap in the radial direction of the slide bearing between the outer peripheral surface of the slide bearing and the inner peripheral surface of the bearing holding hole. As a result, since an occurrence of rattling in the second blade body is suppressed, the first blade body and the second blade body can be stably brought into pressure-contact with each other. Therefore, it is possible to provide the cutting device capable of maintaining excellent cutting performance.

According to a fifth aspect of the present invention, in the cutting device according to any one of the first to fourth aspects of the present invention, the slide bearing may include a first bearing which comes into contact with the second blade body; and a second bearing disposed between the first bearing and the support shaft, the support shaft slidably inserted through the second bearing, the second bearing being biased toward the first blade body side by the biasing member, the outer peripheral surface of the second bearing may gradually decrease in diameter from the fixing member side to the first blade body side, and the inner peripheral surface of the first bearing may gradually decrease in diameter from the fixing member side to the first blade body side to correspond to the outer peripheral surface of the second bearing.

With such a configuration, since the slide bearing includes the first bearing coming into contact with the second blade body, and the second bearing disposed between the first bearing and the support shaft, when the second blade body rotates with respect to the support shaft, even if the second bearing is hard to rotate with respect to the support shaft by the biasing due to the biasing member, the first bearing can be rotated with respect to the second bearing. This makes it possible to smoothly move the first blade body and the second blade body.

At this time, since the outer peripheral surface of the second bearing gradually decreases in diameter from the fixing member side toward the first blade body side, at the contact position between the outer peripheral surface of the second bearing and the inner peripheral surface of the first bearing, a part of the biasing force of the biasing member acting on the second bearing toward the first blade body side can be directed outward in the radial direction of the second bearing. Therefore, it is possible to suppress an occurrence of a gap in the radial direction of the second bearing between the first bearing and the second bearing. Therefore, it is possible to suppress the first bearing and the second bearing from rattling, and it is possible to suppress the occurrence of rattling in the second blade body.

According to a sixth aspect of the present invention, in the cutting device according to the fifth aspect of the present invention, the second bearing may include an annular outer member coming into contact with the inner peripheral surface of the first bearing; and an annular inner member disposed between the outer member and the support shaft and biased toward the first blade body side by the biasing member. The outer peripheral surface of the inner member may gradually decrease in diameter from the fixing member side to the first blade body side, and the inner peripheral surface of the outer member may gradually decrease in diameter from the fixing member side to the first blade body side to correspond to the outer peripheral surface of the inner member.

With such a configuration, the second bearing includes an annular outer member that comes into contact with the inner peripheral surface of the first bearing, and an annular inner member that is disposed between the outer member and the support shaft. Accordingly, when the second blade body rotates with respect to the support shaft, even if the inner member of the second bearing is hard to rotate with respect to the shaft by the biasing force due to the biasing member, it is possible to rotate the outer member of the second bearing and the first bearing with respect to the inner member of the second bearing. This makes it possible to smoothly move the first blade body and the second blade body.

At this time, since the outer peripheral surface of the inner member of the second bearing gradually decreases in diameter from the fixing member side to the first blade body side, at the contact position between the outer peripheral surface of the inner member and the inner peripheral surface of the outer member of the second bearing, a part of the biasing force of the biasing member acting on the inner member toward the first blade body side can be directed outward in the radial direction of the inner member. Therefore, it is possible to suppress an occurrence of a gap in the radial direction of the inner member between the outer member and the inner member. Therefore, rattling of the outer member and the inner member can be suppressed, and it is possible to suppress an occurrence of rattling in the second blade.

According to a seventh aspect of the present invention, in the cutting device according to any one of the first to sixth aspects of the present invention, a sliding member may be provided at a position where the first blade body and the second blade body always face each other.

With such a configuration, it is possible to reduce the sliding resistance between the first blade body and the second blade body by the sliding member. Therefore, the movement of the first blade body and the second blade body can be made smooth.

According to an eighth aspect of the present invention, in the cutting device according to the seventh aspect of the present invention, the sliding member may be provided on the first blade body and the second blade body on a side closer to a proximal end than the support shaft, and may bias the first blade body and the second blade body in a direction of separating from each other.

With such a configuration, since the sliding member is provided on the first blade body and the second blade body on the side closer to the proximal end than the support shaft to bias the first blade body and the second blade body in the direction of separating from each other, it is possible to bring the distal end sides of the first blade body and the second blade body close to each other with the support shaft as a fulcrum. As a result, the blade lines provided on the distal end sides of the first blade body and the second blade body can be always pressed against each other, and the cutting performance can be improved.

According to a ninth aspect of the present invention, in the cutting device according to any one of the first aspect to the eighth aspect of the present invention, a rotation stop portion may be provided on at least one of the first blade body and the support shaft to prevent the first blade body and the support shaft from relatively rotating.

With such a configuration, when the fixing member is mounted on the support shaft while supporting the first blade body, it is possible to prevent the support shaft from rotating with respect to the first blade body, by the rotation stop portion. Therefore, the fixing member can be easily attached to and detached from the support shaft, and disassembling and assembling of the first blade body and the second blade body can be easily performed.

According to a tenth aspect of the present invention, in the cutting device according to any one of the first aspect to the ninth aspect of the present invention, a groove may be formed on an end surface of the support shaft on the side of the first blade body in the axial direction of the support shaft.

With such a configuration, it is possible to fix the support shaft by inserting a driver or the like into the groove. Thus, the fixing member can be easily attached to and detached from the support shaft, and disassembling or assembling of the first blade body and the second blade body can be easily performed.

Scissors according to an eleventh aspect of the present invention includes the cutting device according to any one of the first to tenth aspects; a first gripping portion provided on the proximal end side of the first blade body; and a second gripping portion provided on the proximal end side of the second blade body.

With such a configuration, since the scissors include the aforementioned cutting device, excellent cutting performance can be maintained.

### Advantageous Effects of Invention

According to the cutting device of each of the above embodiments, since the second blade body is rotatably supported on the support shaft via the slide bearing, the movement of the first blade body and the second blade body can be made smooth. Moreover, at least one of the second blade body and the slide bearing is provided with a regulating portion which regulates the movement of the slide bearing toward the first blade body side with respect to the second blade body. Therefore, when the slide bearing is biased toward the first blade body side by the biasing member, the biasing force of the biasing member acting on the slide bearing is made to act on the second blade body, thereby making it possible to press the second blade body toward the first blade body. As a result, the first blade body and the second blade body are always brought into pressure contact with each other, and the cutting performance can be maintained. Further, the same effect can be obtained in the scissors equipped with the cutting device.

Therefore, according to each of the above aspects of the present invention, a cutting device and scissors capable of maintaining excellent cutting performance can be provided.

### BRIEF DESCRIPTION OF DRAWINGS

FIG. 1 is a plan view of scissors according to a first embodiment of the present invention.

FIG. 2 is a cross-sectional view taken along a line II-II of FIG. 1.

FIG. 3 is a plan view of the first blade body of the scissors according to the first embodiment.

FIG. 4 is a plan view of a second blade body of scissors according to the first embodiment.

FIG. 5 is a plan view of a support shaft of the scissors according to the first embodiment.

FIG. 6 is an explanatory view showing a modified example of the biasing member, and is a cross-sectional view of a portion corresponding to the line II-II of FIG. 1.

FIG. 7 is an explanatory view of scissors according to a second embodiment of the present invention, and is a cross-sectional view of a portion corresponding to the line II-II of FIG. 1.

FIG. 8 is a plan view of scissors according to a third embodiment of the present invention, and is a cross-sectional view of a portion corresponding to the line II-II of FIG. 1.

FIG. 9 is an explanatory view showing a modified example of the biasing member, and is a cross-sectional view of a portion corresponding to the line II-II of FIG. 1.

FIG. 10 is a plan view of a scissors according to a fourth embodiment of the present invention in a closed state.

FIG. 11 is a plan view of the scissors according to the fourth embodiment in an opened state.

FIG. 12 is a cross-sectional view taken along a line XII-XII of FIG. 10.

FIG. 13 is an explanatory view of scissors according to a fifth embodiment of the present invention, and is a cross-sectional view of a portion corresponding to the line XII-XII of FIG. 10.

FIG. 14 is an explanatory view showing a modified example of the biasing member, and is a cross-sectional view of a portion corresponding to the line XII-XII of FIG. 10.

FIG. 15 is an explanatory view of scissors according to a sixth embodiment of the present invention, and is a cross-sectional view of a portion corresponding to the line XII-XII of FIG. 10.

FIG. 16 is an explanatory view of scissors according to a seventh embodiment of the present invention, and is a cross-sectional view of a portion corresponding to the line XII-XII of FIG. 10.

FIG. 17 is a plan view of a first blade body of scissors according to an eighth embodiment of the present invention.

FIG. 18 is a plan view of the support shaft of the scissors according to the eighth embodiment.

FIG. 19 is a side view of the support shaft of the scissors according to the eighth embodiment.

FIG. 20 is an explanatory view of scissors according to a ninth embodiment of the present invention, and is a cross-sectional of a portion corresponding to a line II-II of FIG. 1.

FIG. 21 is an explanatory showing a modified example of the fixing member, and is a cross-sectional of a portion corresponding to a line II-II of FIG. 1.

### DESCRIPTION OF EMBODIMENTS

Hereinafter, each embodiment of the present invention will be described on the basis of the drawings.

### First Embodiment

First, scissors 1 (cutting device) of the first embodiment will be described.

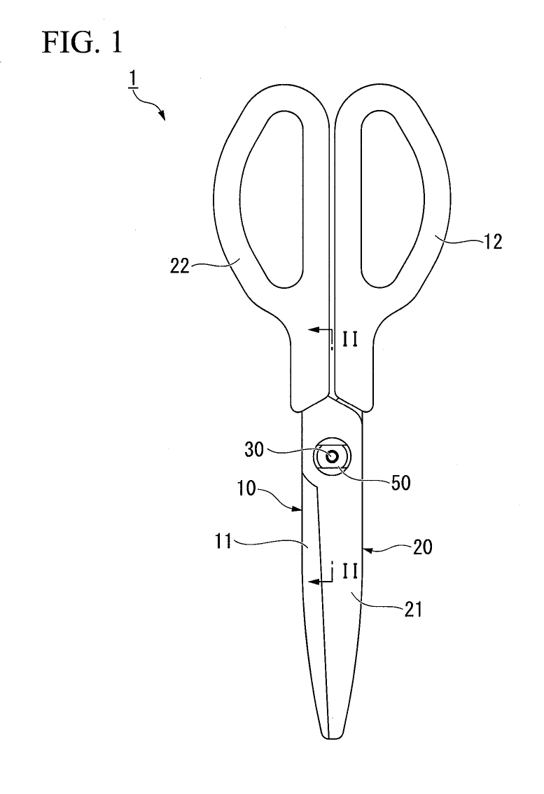

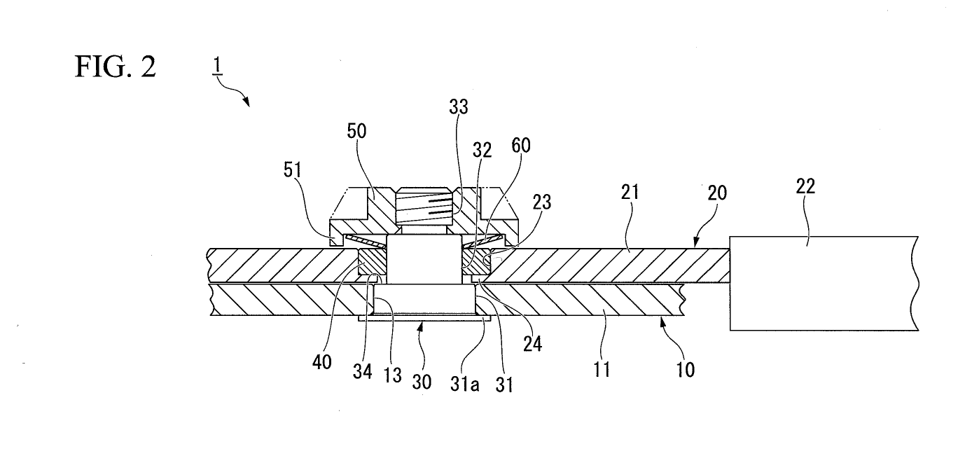

FIG. 1 is a plan view of the scissors according to the first embodiment. FIG. 2 is a cross-sectional view taken along a line II-II of FIG. 1.

As shown in FIGS. 1 and 2, the scissors 1 are so-called western shears. The scissors 1 include a first blade body 10 which holds a support shaft 30, and a second blade body 20 provided to overlap the first blade body 10 and rotatably supported on the support shaft 30 via a slide bearing 40. The first blade body 10 and the second blade body 20 are curved to gradually approach each other from the support shaft 30 toward a tip. In the following description, in an axial direction of the support shaft 30 (hereinafter simply referred to as “axial direction”), the side of the second blade body 20 as viewed from the first blade body 10 is referred to as an upper side, and an opposite side thereof is referred to as a lower side.

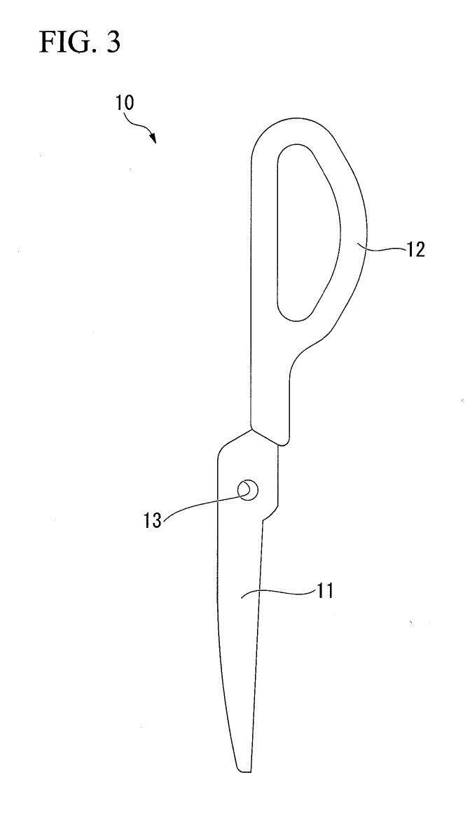

FIG. 3 is a plan view of the first blade body of the scissors according to the first embodiment.

As shown in FIG. 3, the first blade body 10 includes a first base body 11 formed of a metal plate having a thickness in the axial direction, and a first gripping portion 12 attached to the proximal end portion of the first base body 11. A blade line is formed on the first base body 11. The upper surface of the first base body 11 is formed in a planar shape. A support shaft insertion hole 13 through which the support shaft 30 (see FIG. 2) is inserted is formed in the first base body 11. The support shaft insertion hole 13 is formed in a circular shape when viewed in a cross section, and penetrates the first base body 11 with a constant inner diameter in the axial direction. The first gripping portion 12 is provided on a proximal end side of the first blade body 10. The first gripping portion 12 is formed in a ring shape, for example, by a resin material or the like.

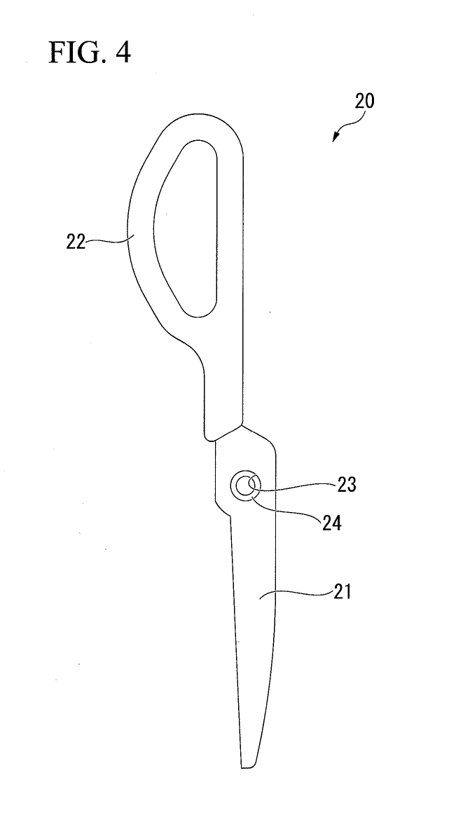

FIG. 4 is a plan view of the second blade body of the scissors according to the first embodiment.

As shown in FIG. 4, the second blade body 20 includes a second base body 21 formed of a metal plate having a thickness in the axial direction, and a second gripping portion 22 attached to the proximal end portion of the second base body 21. A blade line is formed on the second base body 21. The lower surface of the second base body 21 is formed in a planar shape. A bearing holding hole 23 into which the slide bearing 40 (see FIG. 2) is press-fitted or inserted is formed in the second base body 21. The bearing holding hole 23 is formed in a circular shape when viewed in a cross section, and penetrates the second base body 21 with a constant inner diameter in the axial direction. The inner diameter of the bearing holding hole 23 is set to be larger than the inner diameter of the support shaft insertion hole 13 (see FIG. 2). An inner flange portion 24 (regulating portion) is provided on the lower end portion of the bearing holding hole 23. The inner flange portion 24 regulates the movement of the slide bearing 40 toward the first blade body 10 with respect to the second blade body 20 (see FIG. 2). The second gripping portion 22 is provided on the proximal end side of the second blade body 20. The second gripping portion 22 is formed by, for example, a resin material or the like in a ring shape.

As shown in FIG. 2, the support shaft 30 is press-fitted into the support shaft insertion hole 13 of the first blade body 10. The support shaft 30 includes a large-diameter portion 31 formed at the lower end portion, a small-diameter portion 32 connected to the upper end of the large-diameter portion 31, and a male screw portion 33 which is smaller in diameter than the small-diameter portion 32 and connected to the upper end of the small-diameter portion 32. The large-diameter portion 31, the small-diameter portion 32, and the male screw portion 33 are coaxially disposed.

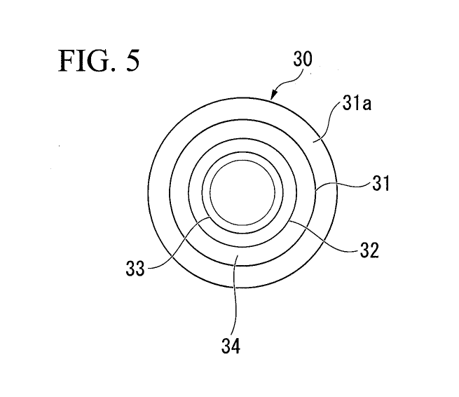

FIG. 5 is a plan view of the support shaft of the scissors according to the first embodiment.

As shown in FIGS. 2 and 5, the large-diameter portion 31 is formed in a circular shape when viewed in a cross section, and is press-fitted into the support shaft insertion hole 13. An outer flange portion 31a is formed at a lower end portion of the large-diameter portion 31. The upper surface of the outer flange portion 31a abuts on the lower surface of the first base body 11. A stepped surface 34 between the large-diameter portion 31 and the small-diameter portion 32 is flush with the upper surface of the first base body 11.

The small-diameter portion 32 is formed in a circular shape when viewed in a cross section. The upper end portion of the small-diameter portion 32 is located above the upper surface of the second base body 21.

As shown in FIG. 2, an annular slide bearing 40 is slidably externally fitted to the small-diameter portion 32. The slide bearing 40 is made of, for example, a resin material with good slidability, such as polyacetal, polyamide, polytetrafluoroethylene, polyphenylene sulfide, polyethylene, an elastomer, a polyolefin, a thermosetting resin, or a so-called super engineering plastic. As the slide bearing 40, in addition to the aforementioned resin bearing, it is also possible to use, for example, an oil-retaining bearing, a slide bearing formed of ceramics or the like, a slide bearing coated with a hard film such as diamond-like carbon on the surface. The slide bearing 40 is formed uniformly in the axial direction. The upper end surface of the slide bearing 40 is flush with the upper surface of the second base body 21 of the second blade body 20.

A fixing member 50 is mounted on the support shaft 30 on the side opposite to the first blade body 10 across the slide bearing 40 (that is, above the slide bearing 40). The fixing member 50 is a nut member screwed onto the male screw portion 33 of the support shaft 30 and having a circular shape in a plan view. In the fixing member 50, an annular surrounding wall 51 extending downward from the outer peripheral edge portion thereof is formed. The lower end edge of the surrounding wall 51 is slightly spaced apart from the upper surface of the second base body 21. The surrounding wall 51 surrounds the upper end portion of the slide bearing 40 from the outside in the radial direction.

A biasing member 60 is disposed between the slide bearing 40 and the fixing member 50. The biasing member 60 is a disc spring. An inner peripheral edge of the biasing member 60 slidably abuts against the upper end surface of the slide bearing 40 from the upper side. The outer peripheral edge of the biasing member 60 abuts against the lower surface of the fixing member 50 from the lower side. Thus, the slide bearing 40 is biased toward the first blade body 10 with respect to the fixing member 50 by the biasing member 60.

In this way, according to the present embodiment, since the second blade body 20 is rotatably supported on the support shaft 30 via the slide bearing 40, the movement of the first blade body 10 and the second blade body 20 can be made smooth. Moreover, an inner flange portion 24 which regulates the movement of the slide bearing 40 toward the first blade body 10 side with respect to the second blade body 20 is provided on at least one (in the present embodiment, the second blade body 20) of the second blade body 20 and the slide bearing 40. Therefore, when the slide bearing 40 is biased toward the first blade body 10 side by the biasing member 60, the biasing force of the biasing member 60 acting on the slide bearing 40 is made to act on the second blade body 20, thereby making it possible to press the second blade body 20 toward the first blade body 10. As a result, the first blade body 10 and the second blade body 20 are always in pressure contact with each other, and the cutting performance can be maintained. Therefore, it is possible to provide the scissors 1 capable of maintaining excellent cutting performance.

Further, since the fixing member 50 covers the upper end portion of the slide bearing 40 by the bottom surface thereof and the surrounding wall 51, dust or the like can be prevented from entering the sliding portion or the like between the slide bearing 40 and the support shaft 30, and the sliding friction can be suppressed from increasing. Therefore, the first blade body 10 and the second blade body 20 can be moved smoothly.

Further, in the first embodiment, the biasing member 60 is a disc spring, but the invention is not limited thereto, and the biasing member 60 may be, for example, a compression coil spring, a wave washer, or the like.

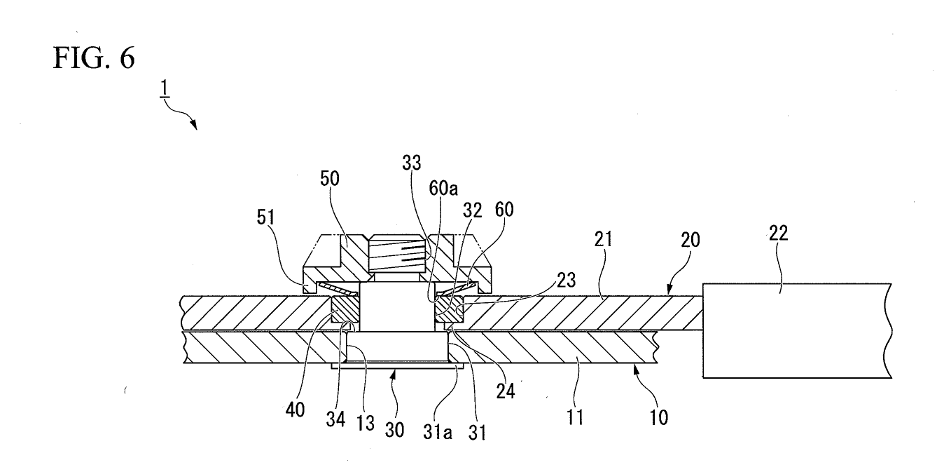

FIG. 6 is an explanatory view showing a modified example of the biasing member, and is a cross-sectional view of a portion corresponding to the line II-II of FIG. 1.

Further, as shown in FIG. 6, the biasing member 60 may have a seating surface 60a on the side of the slide bearing 40. According to this configuration, since the biasing member 60 can be brought into contact with the slide bearing 40 on the surface, an increase in sliding friction of the slide bearing 40 can be suppressed. Therefore, the movement of the first blade body 10 and the second blade body 20 can be made smooth.

### Second Embodiment

Next, scissors 101 of a second embodiment will be described.

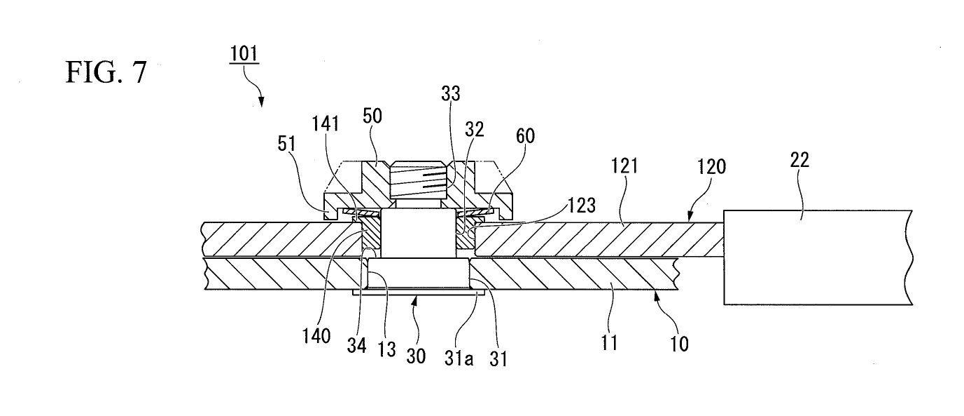

FIG. 7 is an explanatory view of the scissors according to the second embodiment, and is a cross-sectional view of a portion corresponding to the line II-II of FIG. 1.

In the first embodiment shown in FIG. 2, the bearing holding hole 23 of the second blade body 20 includes the inner flange portion 24. In contrast, the second embodiment shown in FIG. 7 differs from the first embodiment in that the bearing holding hole 123 of the second blade body 120 penetrates in the axial direction with a constant inner diameter. Further, in the first embodiment shown in FIG. 2, the slide bearing 40 is uniformly formed along the axial direction. In contrast, the second embodiment shown in FIG. 7 is different from the first embodiment in that the slide bearing 140 includes an outer flange 141 (regulating portion). Further, the same reference numerals are given to the same configurations as those in the above-described embodiment, and the detailed description thereof will not be provided (the same applies to each of the following embodiments).

As shown in FIG. 7, the slide bearing 140 includes an outer flange 141 that protrudes outward in the radial direction. The outer flange 141 is formed on the outer peripheral edge of the slide bearing 140 on the opposite side (that is, the upper side) to the first blade body 10. The lower surface of the outer flange 141 abuts against the upper surface of the second base body 121 of the second blade body 120. The outer flange 141 regulates the movement of the slide bearing 140 toward the first blade body 10 with respect to the second blade body 120.

In this way, according to the present embodiment, since the through-hole that penetrates the second base body 121 with a constant inner diameter in the axial direction can be set as the bearing holding hole 123, the second blade body 120 can be manufactured at the same low cost as in the conventional scissors.

### Third Embodiment

Next, scissors 201 of the third embodiment will be described.

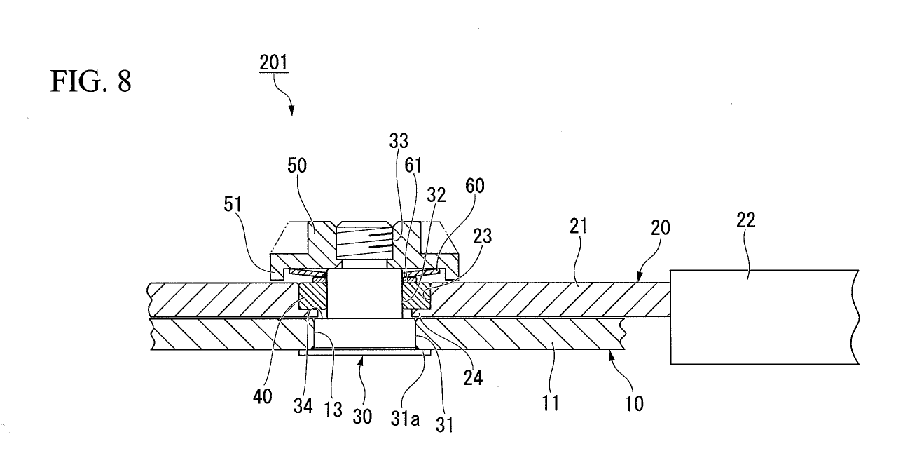

FIG. 8 is an explanatory view of the scissors according to the third embodiment, and is a cross-sectional view of a portion corresponding to the line II-II of FIG. 1.

In the first embodiment shown in FIG. 2, the slide bearing 40 and the biasing member 60 are in contact with each other. In contrast, the third embodiment shown in FIG. 8 is different from the first embodiment in that, for example, an annular spacer 61 is interposed between the slide bearing 40 and the biasing member 60.

In this way, according to the present embodiment, since the spacer 61 is interposed between the slide bearing 40 and the biasing member 60, it is possible to suppress the direct sliding-contact between the slide bearing 40 and the biasing member 60. Therefore, an increase in the sliding friction of the slide bearing 40 can be suppressed, and the movement of the first blade body 10 and the second blade body 20 can be made smooth. Therefore, the scissors 201 capable of maintaining excellent cutting performance can be provided.

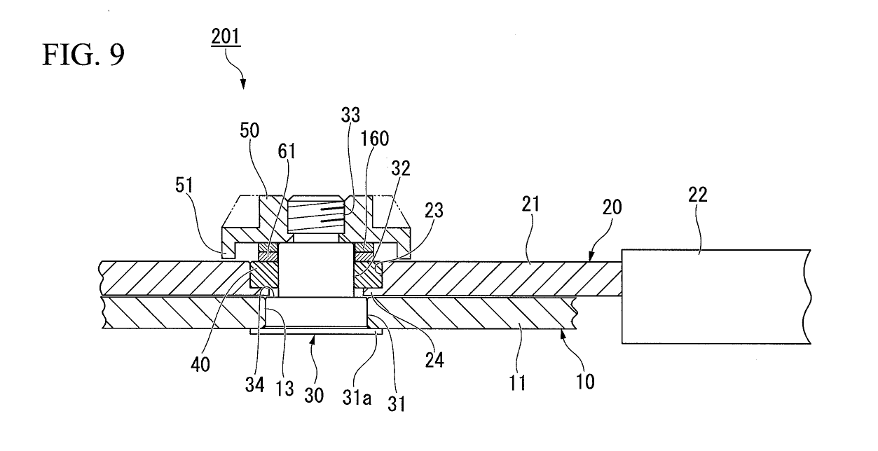

FIG. 9 is an explanatory view showing a modified example of the biasing member, and is a cross-sectional view of a portion corresponding to the line II-II of FIG. 1.

Further, as shown in FIG. 9, the slide bearing 40 may be biased toward the first blade body 10 side, by the annular biasing member 160 formed of, for example, an elastic material such as rubber, silicone rubber, and urethane.

### Fourth Embodiment

Next, scissors 301 of a fourth embodiment will be described.

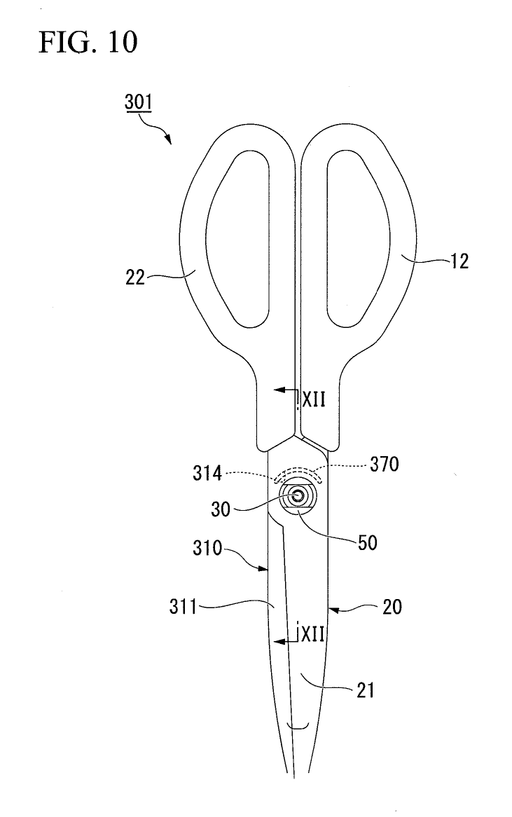

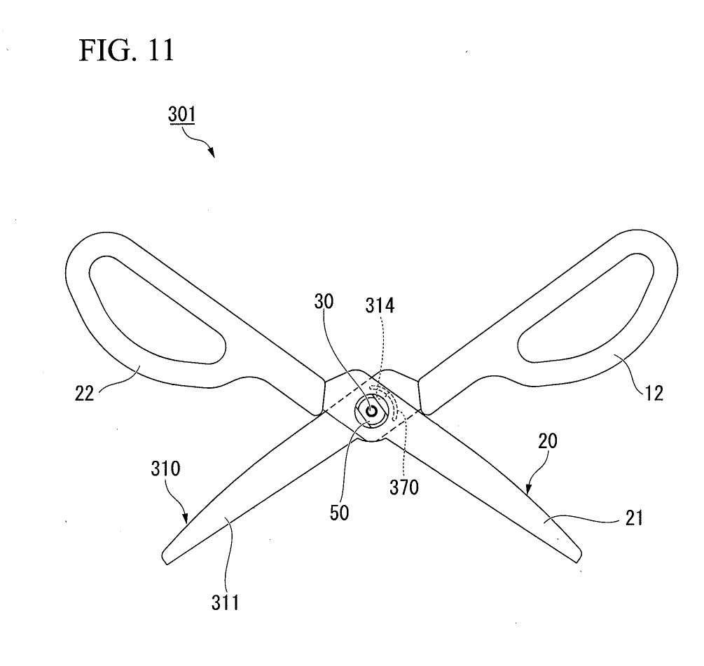

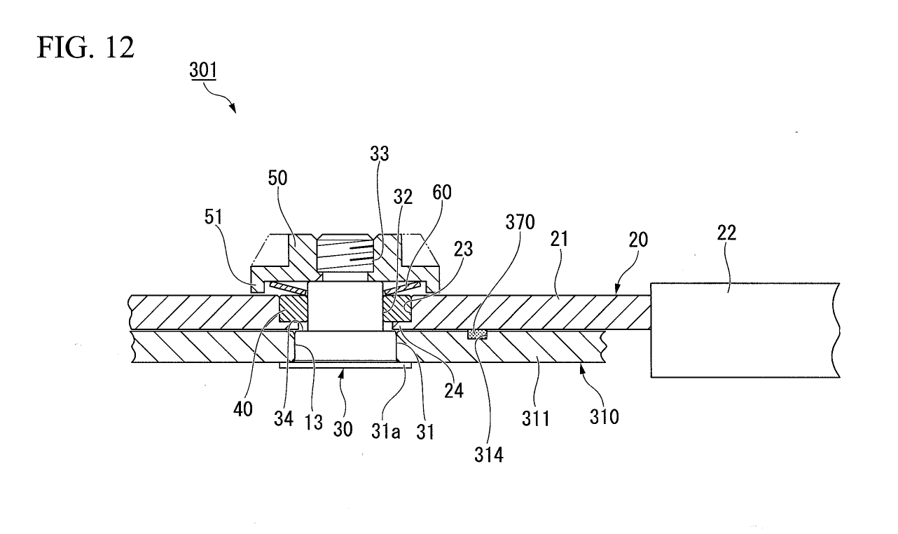

FIG. 10 is a plan view of the scissors in the closed state according to the fourth embodiment. FIG. 11 is a plan view of the scissors according to the fourth embodiment in an open state. FIG. 12 is a cross-sectional view taken along the line XII-XII of FIG. 10.

In the first embodiment shown in FIG. 2, the first blade body 10 and the second blade body 20 directly overlap each other. In contrast, the fourth embodiment shown in FIGS. 10 to 12 is different from the first embodiment in that a sliding member 370 is provided between the first blade body 310 and the second blade body 20.

As shown in FIGS. 10 to 12, the scissors 301 include a sliding member 370. The sliding member 370 is provided on the first blade body 310 and the second blade body 20 on the side closer to the proximal end than the support shaft 30 and at a position where the first blade body 310 and the second blade body 20 always face each other. The sliding member 370 is formed to extend along the circumferential direction around the support shaft 30 as viewed from the axial direction. As shown in FIG. 12, the sliding member 370 is disposed in a housing groove 314 formed on the upper surface of the first base body 311 of the first blade body 310. The housing groove 314 is formed to correspond to the shape of the sliding member 370. The upper surface of the sliding member 370 abuts against the lower surface of the second base body 21 of the second blade body 20. The sliding member 370 biases the first blade body 310 and the second blade body 20 in a direction of separating from each other.

According to the present embodiment, since the sliding member 370 is provided at a position where the first blade body 310 and the second blade body 20 always face each other, the sliding resistance between the first blade body 310 and the second blade body 20 can be reduced. Therefore, the movement of the first blade body 310 and the second blade body 20 can be made smooth.

Further, since the sliding member 370 is provided on the first blade body 310 and the second blade body 20 on the side closer to the proximal end than the support shaft 30 to bias the first blade body 310 and the second blade body 20 in the direction of separating from each other, it is possible to bring the distal end sides of the first blade body 310 and the second blade body 20 close to each other with the support shaft 30 as a fulcrum. As a result, the blade lines provided on the distal end sides of the first blade body 310 and the second blade body 20 can be always pressed against each other, and the cutting performance can be improved.

### Fifth Embodiment

Next, scissors 401 of the fifth embodiment will be described.

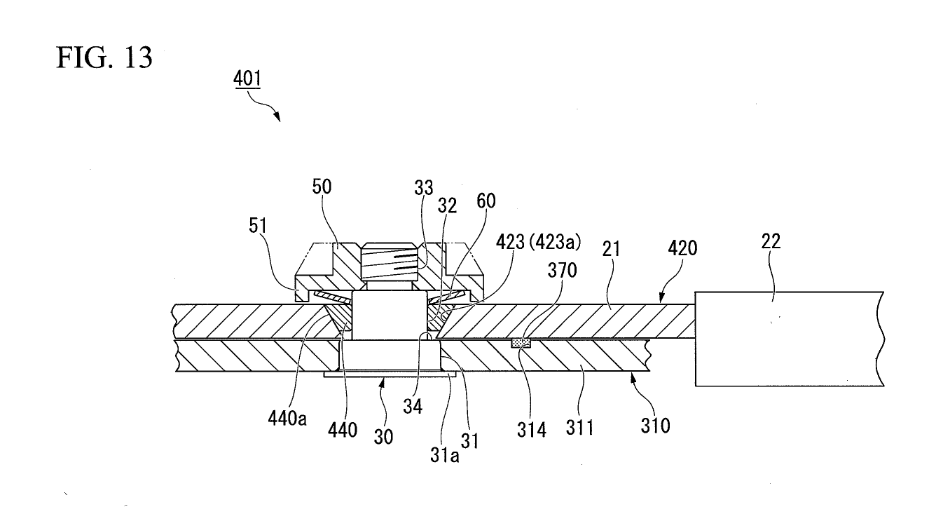

FIG. 13 is an explanatory view of the scissors according to the fifth embodiment and is a cross-sectional view in a portion corresponding to the line XII-XII of FIG. 10.

In the fourth embodiment shown in FIG. 12, the slide bearing 40 is uniformly formed in the axial direction. In contrast, the fifth embodiment shown in FIG. 13 is different from the fourth embodiment in that an outer peripheral surface 440a (regulating portion) of the slide bearing 440 is gradually reduced in diameter from the fixing member 50 side toward the first blade body 310 side. Further, in the fourth embodiment shown in FIG. 12, the bearing holding hole 23 of the second blade body 20 penetrates in the axial direction with a constant inner diameter. In contrast, the fifth embodiment shown in FIG. 13 is different from the fourth embodiment in that the inner peripheral surface 423a (regulating portion) of the bearing holding hole 423 of the second blade body 420 gradually decreases in diameter from the fixing member 50 side toward the first blade body 310 side.

As shown in FIG. 13, the outer peripheral surface 440a of the slide bearing 440 is an inclined surface that gradually decreases in diameter from the fixing member 50 side toward the first blade body 310 side. The inner peripheral surface 423a of the bearing holding hole 423 is an inclined surface that gradually decreases in diameter from the fixing member 50 side toward the first blade body 310 side to correspond to the outer peripheral surface 440a of the slide bearing 440. The outer peripheral surface 440a of the slide bearing 440 and the inner peripheral surface 423a of the bearing holding hole 423 regulate the movement of the slide bearing 440 toward the first blade body 310 with respect to the second blade body 420.

In this way, according to the present embodiment, a part of the biasing force acting on the slide bearing 440 toward the first blade body 310 by the biasing member 60 can be directed outward in the radial direction of the slide bearing 440 at the contact portion between the outer peripheral surface 440a of the slide bearing 440 and the inner peripheral surface 423a of the bearing holding hole 423. Therefore, it is possible to suppress occurrence of radial gap between the outer peripheral surface 440a of the slide bearing 440 and the inner peripheral surface 423a of the bearing holding hole 423. As a result, since occurrence of rattling in the second blade body 420 is suppressed, the first blade body 310 and the second blade body 420 can be stably brought into pressure-contact with each other. Therefore, it is possible to provide the scissors 401 capable of maintaining excellent cutting performance.

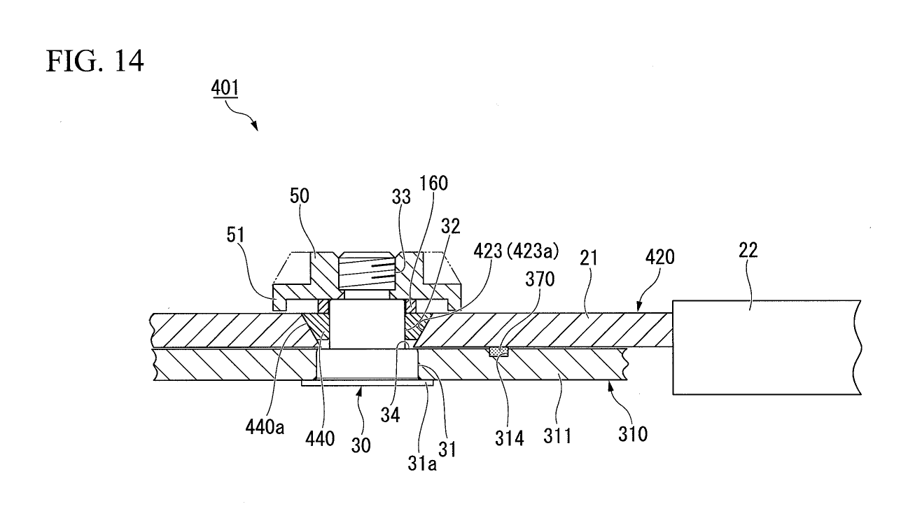

FIG. 14 is an explanatory view showing a modified example of the biasing member, and is a cross-sectional view of a portion corresponding to the line XII-XII of FIG. 10.

Further, in the fifth embodiment, similarly to the modified example of the third embodiment shown in FIG. 9, as shown in FIG. 14, it is also possible to use an annular biasing member 160 formed of, for example, an elastic material such as rubber, silicone rubber, and urethane.

### Sixth Embodiment

Next, scissors 501 of the sixth embodiment will be described.

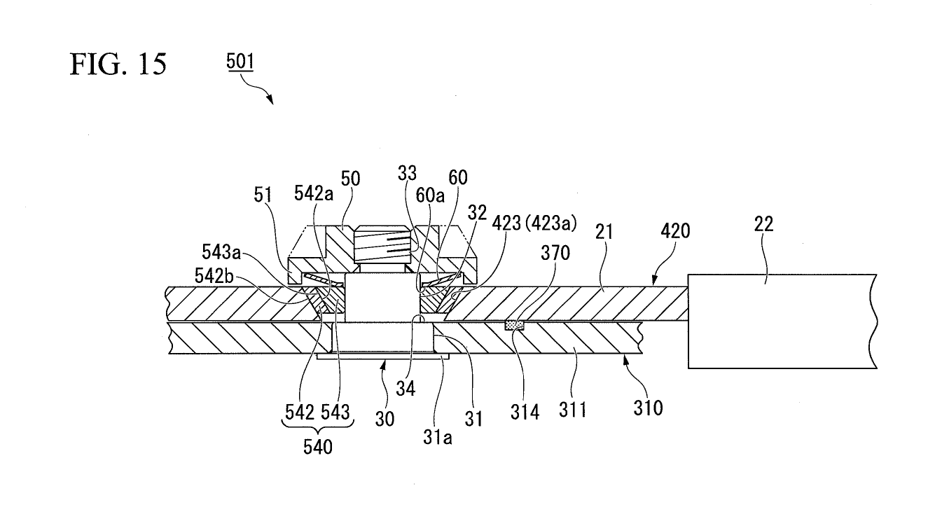

FIG. 15 is an explanatory view of the scissors according to the sixth embodiment, and is a cross-sectional view of a portion corresponding to the line XII-XII of FIG. 10.

In the fifth embodiment shown in FIG. 13, the slide bearing 440 is configured as a single member. In contrast, the sixth embodiment shown in FIG. 15 is different from the fifth embodiment in that a slide bearing 540 includes a first bearing 542 and a second bearing 543.

As shown in FIG. 15, the slide bearing 540 includes the first bearing 542 coming into contact with the second blade body 420, and the second bearing 543 disposed between the first bearing 542 and the support shaft 30.

The support shaft 30 is slidably inserted through the second bearing 543. The second bearing 543 is formed in an annular shape, for example, by a resin material, a metal material, or the like. The outer peripheral surface 543a of the second bearing 543 is an inclined surface that gradually decreases in diameter from the fixing member 50 side toward the first blade body 310 side. The second bearing 543 is biased toward the first blade body 310 side by the biasing member 60.

The first bearing 542 is formed in an annular shape, for example, of a resin material. The inner peripheral surface 542a of the first bearing 542 is an inclined surface that gradually decreases in diameter from the fixing member 50 side toward the first blade body 310 side. The inner peripheral surface 542a of the first bearing 542 is formed to correspond to the outer peripheral surface 543a of the second bearing 543. The outer peripheral surface 542b of the first bearing 542 is an inclined surface that gradually decreases in diameter from the fixing member 50 side toward the first blade body 310 side. The outer peripheral surface 542b of the first bearing 542 is formed to correspond to the inner peripheral surface 423a of the bearing holding hole 423.

In this way, according to the present embodiment, since the slide bearing 540 includes the first bearing 542 coming into contact with the second blade body 420, and the second bearing 543 disposed between the first bearing 542 and the support shaft 30, when the second blade body 420 rotates with respect to the support shaft 30, even if the second bearing 543 does not easily rotate with respect to the support shaft 30 due to the biasing from the biasing member 60, the first bearing 542 can be rotated with respect to the second bearing 543. This makes it possible to move the first blade body 310 and the second blade body 420 smoothly.

At this time, since the outer peripheral surface 543a of the second bearing 543 gradually decreases in diameter from the fixing member 50 side toward the first blade body 310 side, at the contact position between the outer peripheral surface 543a of the second bearing 543 and the inner peripheral surface 542a of the first bearing 542, a part of the biasing force of the biasing member 60 acting on the second bearing 543 toward the first blade body 310 side can be directed outward in the radial direction. Therefore, it is possible to suppress occurrence of a radial gap between the first bearing 542 and the second bearing 543. Therefore, it is possible to suppress the first bearing 542 and the second bearing 543 from rattling, and it is possible to suppress the occurrence of rattling in the second blade body 420.

### Seventh Embodiment

Next, scissors 601 of a seventh embodiment will be described.

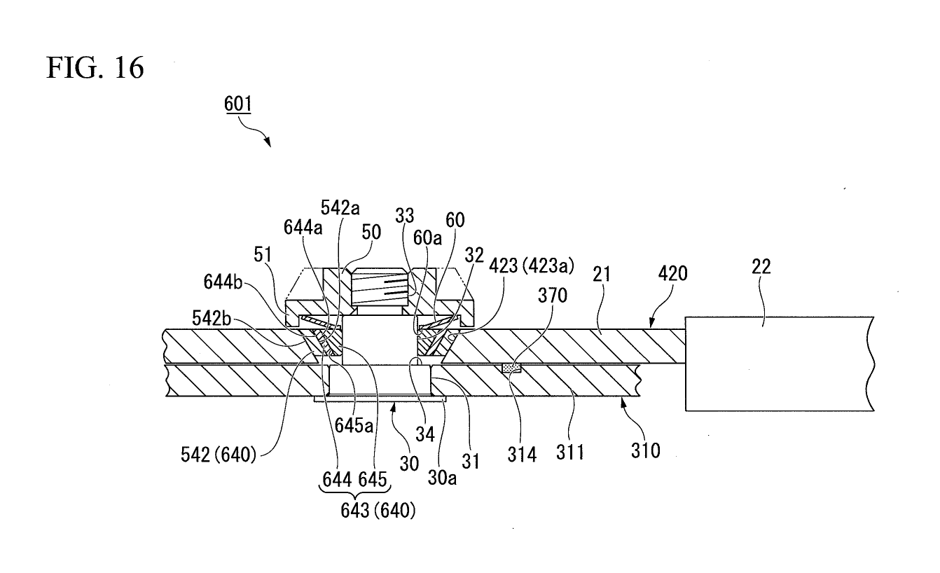

FIG. 16 is an explanatory view of the scissors according to the seventh embodiment and is a cross-sectional view of a portion corresponding to the line XII-XII of FIG. 10.

In the sixth embodiment shown in FIG. 15, the second bearing 543 is configured as a single member. In contrast, the seventh embodiment shown in FIG. 16 is different from the sixth embodiment in that the second bearing 643 includes an outer member 644 and an inner member 645.

As shown in FIG. 16, the slide bearing 640 includes the first bearing 542 and the second bearing 643. The second bearing 643 includes the annular outer member 644 coming into contact with the inner peripheral surface 542a of the first bearing 542, and the annular inner member 645 disposed between the outer member 644 and the support shaft 30.

The support shaft 30 is slidably inserted through the inner member 645. The inner member 645 is made of, for example, a resin material. The outer peripheral surface 645a of the inner member 645 is an inclined surface that gradually decreases in diameter from the fixing member 50 side toward the first blade body 310 side. The inner member 645 is biased toward the first blade body 310 side by the biasing member 6Q.

The outer member 644 is made of a material different from that of the first bearing 542 and the inner member 645, such as a metal material. The inner peripheral surface 644a of the outer member 644 is an inclined surface that gradually decreases in diameter from the fixing member 50 side toward the first blade body 310 side. The inner peripheral surface 644a of the outer member 644 is formed to correspond to the outer peripheral surface 645a of the inner member 645. The outer peripheral surface 644b of the outer member 644 is an inclined surface that gradually decreases in diameter from the fixing member 50 side toward the first blade body 310 side. The outer peripheral surface 644b of the outer member 644 is formed to correspond to the inner peripheral surface 542a of the first bearing 542.

In this way, according to the present embodiment, the second bearing 643 includes an annular outer member 644 that comes into contact with the inner peripheral surface 542a of the first bearing 542, and an annular inner member 645 that is disposed between the outer member 644 and the support shaft 30. Accordingly, when the second blade body 420 rotates with respect to the support shaft 30, even if the inner member 645 of the second bearing 643 does not easily rotate with respect to the shaft 30 due to the biasing force from the biasing member 60, it is possible to rotate the outer member 644 of the second bearing 643 and the first bearing 542 with respect to the inner member 645 of the second bearing 643. This makes it possible to move the first blade body 310 and the second blade body 420 smoothly.

At this time, since the outer peripheral surface 645a of the inner member 645 of the second bearing 643 gradually decreases in diameter from the fixing member 50 side to the first blade body 310 side, at the contact position between the outer peripheral surface 645a of the inner member 645 and the inner peripheral surface 644a of the outer member 644 of the second bearing 643, a part of the biasing force of the biasing member 60 toward the first blade body 310 side acting on the inner member 645 of the second bearing 643 can be directed outward in the radial direction. Therefore, it is possible to suppress occurrence of a radial gap between the outer member 644 and the inner member 645. Therefore, rattling of the outer member 644 and the inner member 645 can be suppressed, and it is possible to suppress occurrence of rattling in the second blade 420.

In addition, since the outer member 644 of the second bearing 643 is made of a material different from that of the first bearing 542 and the inner member 645 of the second bearing 643, it is possible to lower the sliding resistance at the contact position between the outer member 644 and the first bearing 542, and at the contact position between the outer member 644 and the inner member 645. Therefore, the movement of the first blade body 310 and the second blade body 420 can be made smooth.

### Eighth Embodiment

Next, scissors 701 of an eighth embodiment will be described.

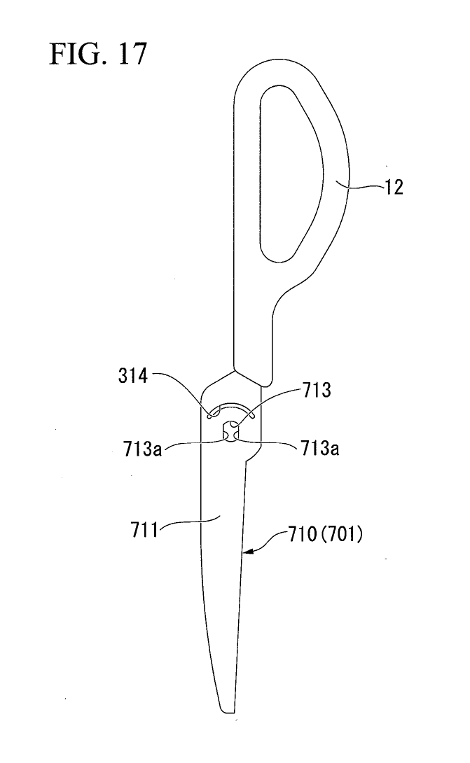

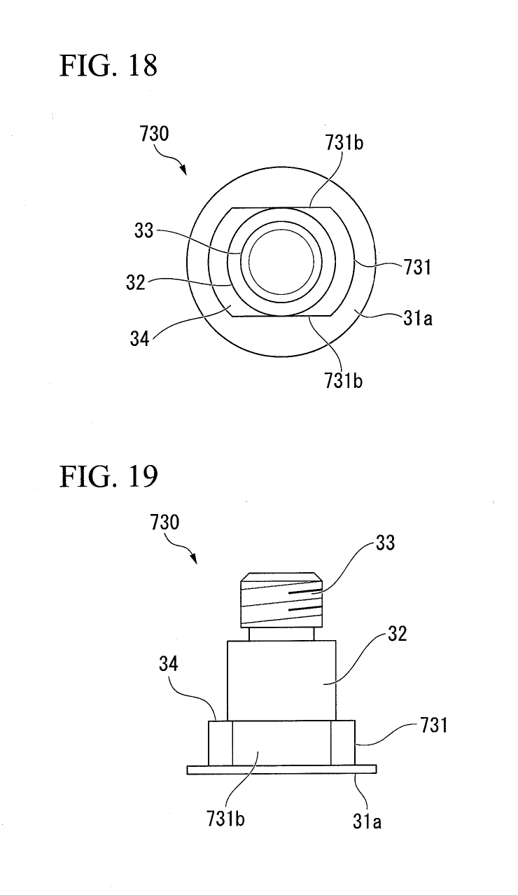

FIG. 17 is a plan view of the first blade body of the scissors according to the eighth embodiment. FIG. 18 is a plan view of the support shaft of scissors according to the eighth embodiment. FIG. 19 is a side view of the support shaft of scissors according to the eighth embodiment.

In the first embodiment shown in FIG. 3, the support shaft insertion hole 13 is formed in a circular shape in a cross-sectional view. In contrast, the eighth embodiment shown in FIG. 17 differs from the first embodiment in that a support shaft insertion hole 713 is formed in a non-circular shape (different shape) in a cross-sectional view. Further, in the first embodiment shown in FIG. 5, the large-diameter portion 31 of the support shaft 30 is formed in a circular shape in a cross-sectional view. In contrast, the sixth embodiment shown in FIG. 18 is different from the first embodiment in that a large-diameter portion 731 of the support shaft 730 is formed in a noncircular shape (different shape) in a cross-sectional view.

As shown in FIG. 17, on the inner peripheral surface of the support shaft insertion hole 713 in the first base body 711 of the first blade body 710, a pair of two-way chamfered surfaces 713a (rotation stop portions) facing each other is formed.

As shown in FIGS. 18 and 19, the support shaft 730 includes a large-diameter portion 731 fitted to the support shaft insertion hole 713 (see FIG. 17). The large-diameter portion 731 is formed in a cylindrical shape, and a two-way chamfered portion 731b (rotation stop portion) is formed on both sides in a predetermined radial direction orthogonal to the axial direction. As shown in FIGS. 17 and 18, the two-way chamfered portion 731b is formed in a shape corresponding to the two-way chamfered surface 713a of the support shaft insertion hole 713. As a result, the two-way chamfered surface 713a and the two-way chamfered portion 731b prevent the first blade body 710 and the support shaft 730 from relatively rotating. The support shaft 730 is attachable to and detachable from the first blade body 710, and is press-fitted in a state in which a relative rotation is not allowed.

According to the present embodiment, when the fixing member 50 (see FIG. 2) is mounted to the support shaft 730 while supporting the first blade body 710, it is possible to prevent the support shaft 730 from rotating with respect to the first blade body 710, by the two-way chamfered surface 713a and the two-way chamfered portion 731b which can prevent the first blade body 710 and the support shaft 730 from relatively rotating. Therefore, the fixing member 50 can be easily attached to and detached from the support shaft 730, and disassembling and assembling of the first blade body 710 and the second blade body 20 (see FIG. 2) can be easily performed.

Further, in this embodiment, by two-way chamfering (two chamfering) the support shaft insertion hole 713 and the support shaft 730, the first blade body 710 and the support shaft 730 can be disassembled and can be prevented from relatively rotating. However, the invention is not limited thereto. The first blade body and the support shaft may be disassembled from each other and may be prevented from relatively rotating, and these connection positions may be formed in a non-circular shape such as a polygonal shape when viewed from the axial direction. Further, the first blade body and the support shaft may be prevented from relatively rotating by a rotation stop portion such as a pin.

### Ninth Embodiment

Next, scissors 801 of a ninth embodiment will be described.

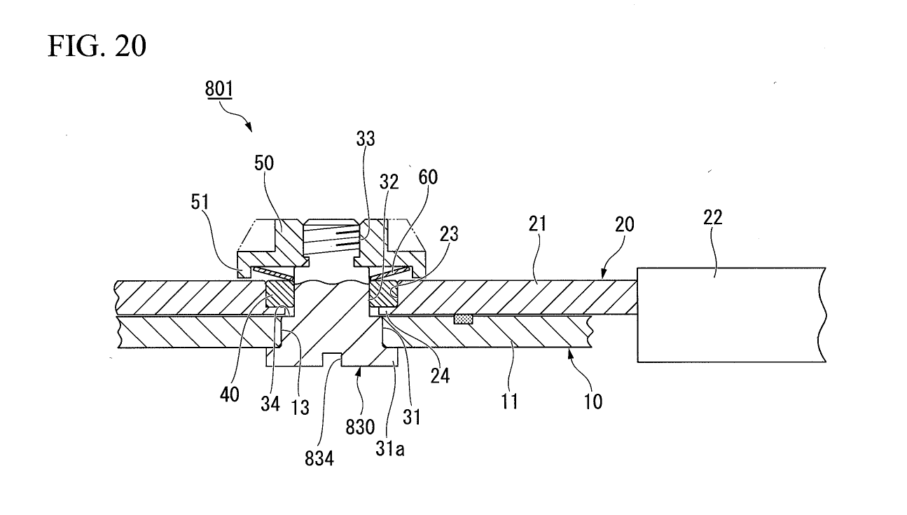

FIG. 20 is an explanatory view of the scissors according to the ninth embodiment, and is a cross-sectional view of a portion corresponding to the line II-II of FIG. 1.

In the first embodiment shown in FIG. 2, the lower end surface of the support shaft 30 is formed in a planar shape. In contrast, the ninth embodiment shown in FIG. 20 is different from the first embodiment in that a groove 834 extending along the direction orthogonal to the axial direction is formed on the lower end surface (the end surface on the first blade body 10 side in the axial direction) of the support shaft 830.

According to the present embodiment, since the groove 834 is formed on the lower end surface of the support shaft 830, it is possible to fix the support shaft 830 by inserting a driver or the like into the groove 834. Thus, the fixing member 50 can be easily attached to and detached from the support shaft 830, and disassembling or assembling of the first blade body 10 and the second blade body 20 can be easily performed.

It should be noted that the present invention is not limited to the embodiments described with reference to the drawings, and various modifications are conceivable within the technical scope thereof.

For example, in each of the above embodiments, the scissors are described as an example of the cutting device as an example, but the present invention is not limited thereto, and the cutting device may be, for example, a cutter.

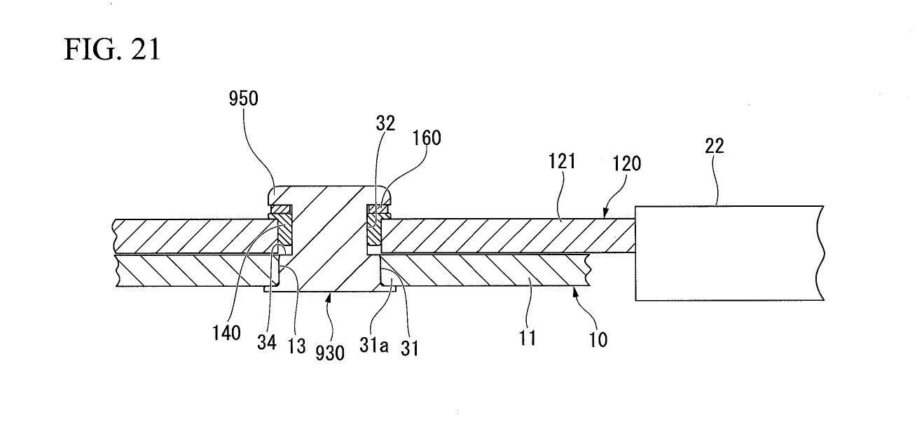

Further, in each of the above-described embodiments, the fixing member is a nut member screwed to the upper end portion (male screw portion) of the support shaft, but the present invention is not limited thereto. As shown in FIG. 21, the fixing member 950 may be a caulked portion obtained by buckling and deforming the upper end portion of the support shaft 930.

In addition, it is possible to appropriately substitute the constituent elements in the above-described embodiment with well-known constituent elements within a scope that does not depart from the gist of the present invention.

### INDUSTRIAL APPLICABILITY

According to the cutting device of each of the above embodiments, since the second blade body is rotatably supported on the support shaft via the slide bearing, the movement of the first blade body and the second blade body can be made smooth. Further, at least one of the second blade body and the slide bearing is provided with a regulating portion that regulates the movement of the slide bearing toward the first blade body with respect to the second blade body. Therefore, by biasing the slide bearing toward the first blade body side by the biasing member, the biasing force of the biasing member acting on the slide bearing is applied to the second blade body, thereby making it possible to press the second blade body against the first blade body. As a result, the first blade body and the second blade body are always brought into pressure-contact with each other, and cutting performance can be maintained. Further, the same effect can be obtained in the scissors equipped with this cutting device.

Therefore, according to each of the above-described embodiments, since it is possible to provide a cutting device and scissors capable of maintaining excellent cutting performance, the industrial applicability is great.

### REFERENCE SIGNS LIST

1, 101, 201, 301, 401, 501, 601, 701, 801 Scissors (cutting device)
10, 310, 710 First blade body
12 First gripping portion
20, 120, 420 Second blade body
22 Second gripping portion
24 Inner flange portion (regulating portion)
30, 730, 830, 930 Support shaft
40, 140, 440, 540, 640 Slide bearing
50, 950 Fixing member
60, 160 Biasing member
60a Seating surface
61 Spacer
141 Outer flange (regulating portion)
370 Sliding member
423 Bearing holding hole
423a Inner peripheral surface of bearing holding hole
542 First bearing
542a Inner peripheral surface of first bearing
543, 643 Second bearing
543a Outer peripheral surface of second bearing
644 Outer member
644a Inner peripheral surface of outer member
645 Inner member
645a Outer peripheral surface of inner member
713a Two-way chamfered surface (rotation stop portion)
731b Two-way chamfered portion (rotation stop portion)
834 Groove

1. A cutting device comprising:
a support shaft;
a first blade body which holds the support shaft;
a slide bearing mounted on the support shaft;
a second blade body provided to overlap the first blade body and rotatably supported on the support shaft via the slide bearing;
a fixing member disposed on the support shaft on a side opposite to the first blade body across the slide bearing; and
a biasing member disposed between the slide bearing and the fixing member,
wherein a regulating portion is provided in at least one of the second blade body and the slide bearing, the regulating portion regulating movement of the slide bearing toward the first blade body side with respect to the second blade body, and
the slide bearing is biased toward the first blade body side by the biasing member.

2. The cutting device according to claim 1, wherein a spacer is interposed between the slide bearing and the biasing member.

3. The cutting device according to claim 1, wherein the biasing member has a seating surface on the side of the slide bearing.

4. The cutting device according to claim 1, wherein an outer peripheral surface of the slide bearing gradually decreases in diameter from the fixing member side to the first blade body side,
the second blade body includes a bearing holding hole which holds the slide bearing, and
the bearing holding hole has an inner peripheral surface which gradually decreases in diameter from the fixing member side toward the first blade body side to correspond to the outer peripheral surface of the slide bearing.

5. The cutting device according to claim 1, wherein the slide bearing includes:
a first bearing which comes into contact with the second blade body; and
a second bearing disposed between the first bearing and the support shaft, the support shaft slidably inserted through the second bearing, the second bearing being biased toward the first blade body side by the biasing member,
the outer peripheral surface of the second bearing gradually decreases in diameter from the fixing member side to the first blade body side, and
the inner peripheral surface of the first bearing gradually decreases in diameter from the fixing member side to the first blade body side to correspond to the outer peripheral surface of the second bearing.

6. The cutting device according to claim 5, wherein the second bearing includes:
an annular outer member coming into contact with the inner peripheral surface of the first bearing; and
an annular inner member disposed between the outer member and the support shaft and biased toward the first blade body side by the biasing member,
the outer peripheral surface of the inner member gradually decreases in diameter from the fixing member side to the first blade body side, and
the inner peripheral surface of the outer member gradually decreases in diameter from the fixing member side to the first blade body side to correspond to the outer peripheral surface of the inner member.

7. The cutting device according to claim 1, wherein a sliding member is provided at a position where the first blade body and the second blade body always face each other.

8. The cutting device according to claim 7, wherein the sliding member is provided on the first blade body and the second blade body on a side closer to a proximal end than the support shaft, and biases the first blade body and the second blade body away from each other.

9. The cutting device according to claim 1, wherein a rotation stop portion is provided on at least one of the first blade body and the support shaft to prevent relative rotation between the first blade body and the support shaft.

10. The cutting device according to claim 1, wherein a groove is formed on an end surface of the support shaft on the side of the first blade body in an axial direction of the support shaft.

11. Scissors comprising:
the cutting device according to claim 1;
a first gripping portion provided on the proximal end side of the first blade body; and
a second gripping portion provided on the proximal end side of the second blade body.
